(19) United States
(12) Patent Application Publication
(10) Pub. No.: US 2005/0120850 A1
(43) Pub. Date: Jun. 9, 2005

(54) Cutting unit

(76) Inventor: Bernd Loibl, Klettgau (DE)

Correspondence Address: Joseph W. Berenato, III;Liniak, Berenato & White, LLC, Suite 240, 6550 Rock Spring Drive, Bethesda, MD, 20817, US

(21) Appl. No.: 10/796,971

(22) Filed: Mar. 11, 2004

(30) Foreign Application Priority Data
Dec. 5, 2003 (DE) 203 18 947.7

(51) Int. Cl. B26D 1/18

(52) U.S. Cl. 83/485; 83/614; 83/563

(57) ABSTRACT

A cutting unit (1) for trimming sheet material (44) such as paper, films, or the like, comprises a planar bed (33) for supporting the sheet material (44). A rotary cutting device (34) has a knife carriage (36) displaceable on a guide bar (35) and a circular knife (39) rotatably mounted thereon. The guide bar (35) is raisable from a lower cutting position into an upper initial position, and lowerable from the latter back into the cutting position. The gap between bed (33) and guide bar (35) is inaccessible from the ends of the guide bar (35).

### CROSS-REFERENCE TO RELATED APPLICATIONS AND CLAIM TO PRIORITY

This application claims the benefit under 35 U.S.C. § 119 of utility model application number 203 18 947.7, filed Dec. 3, 2003, in the Federal Republic of Germany, the disclosure of which is incorporated herein by reference.

### FIELD OF THE INVENTION

The invention concerns a cutting unit for trimming sheet material such as paper, films or the like, having a planar bed for supporting the sheet material and having a rotary cutting device that has a knife carriage displaceable on a guide bar and a circular knife rotatably mounted thereon.

### BACKGROUND OF THE INVENTION

Cutting units of the aforesaid kind are provided in particular for office use. They serve to trim paper sheet material, usually in DIN A4 format and smaller, at most DIN A3 format. The cutting units have a substantially horizontal bed as support for the sheet material. A rotary cutting device is provided on one longitudinal side of the bed. A rotary cutting device of this kind comprises a guide bar extending parallel to the longitudinal side, and a knife carriage displaceable thereon. The knife carriage has a circular knife mounted on a horizontal axis.

Before the cutting operation, the sheet material to be trimmed is slid into the desired position through the gap between guide bar and bed, the knife carriage being located in one of the two end positions. In the cutting operation, the knife carriage is pushed downward against the action of a spring so that the circular knife presses against the bed. The knife carriage is then displaced along the guide bar. The circular knife then performs a rotary movement and cuts the sheet material.

Such cutting units can also be combined with a guillotine cutting device in which there is provided at one corner of the bed a knife arm, mounted pivotably about a horizontal axis, on which is attached a cutting knife projecting on the lower side (cf. DE 203 07 241.3 U1). It corresponds to a counterknife secured on the bed. The guillotine cutting device is arranged on one of the two longitudinal sides of the bed, while the rotary cutting device is arranged on the other longitudinal side.

In practical use, rotary cutting devices of the kind described above have proven impractical. During the cutting operation, the knife carriage must be simultaneously pressed downward and displaced lengthwise. This is not always successful, resulting in ragged or incomplete cuts.

### SUMMARY OF THE INVENTION

It is the object of the invention to embody a cutting unit of the aforesaid kind in such a way that it is easy to operate and nevertheless produces clean cuts.

According to the present invention, this object is achieved in that the guide bar is raisable from a lower cutting position into an upper initial position, and lowerable from the latter back into the cutting position; and the gap between bed and guide bar is inaccessible from the ends of the guide bar. The basic idea of the invention is thus to effect the vertical movement of the circular knife not by way of the knife carriage but by means of the guide bar, by first raising the guide bar in order to slide the sheet stock through and then lowering it into the cutting position in which the circular knife rests on the bed. This makes handling of the cutting operation substantially simpler, and results in clean cuts. It is particularly important in this context that the gap between guide bar and bed be inaccessible from the ends of the guide bar, i.e. be covered there, so that it is not possible for the operator's fingers to enter the gap in that region and get caught as the guide bar is lowered.

In an embodiment of the invention, it is proposed that the guide bar be guided in vertically displaceable fashion in the region of its ends so that it can be raised and lowered parallel to the bed, preferably by no more than 20 mm, preferably approx. 12 mm. As an alternative to this, however, provision can also be made for the guide bar to be mounted pivotably about a horizontal axis in the region of one end, specifically through an angle of at most 10°, preferably an angle of 4 to 5°. In order for the gap between bed and guide bar to be inaccessible at the two ends of the guide bar, those ends should overlap the bed. It is understood that in the context of a pivotably mounted guide bar, this overlap is necessary only at the latter's free end and not in the region of the pivot bearing, since the pivot bearing itself already constitutes a barrier to access to the gap between bed and guide bar. If an overlap is provided, this can be done by way of a downwardly projecting protective tab overlapping the bed. To ensure good lateral guidance of the guide bar in this region, the protective tab should fit into a matching slot in the bed.

The guide bar can be suspended in such a way that without actuation, it assumes the cutting position in which the circular knife rests on the bed. The guide bar can be raised manually in order to slide the sheet material through the gap between guide bar and bed. As an alternative to this, however, the possibility also exists that without actuation, the guide bar is held in the initial position by means of a spring. This facilitates sliding of the sheet material through the gap, but requires that the guide bar be pushed down for the cutting operation. A clean cut is obtained with this embodiment as well, however, since the guide bar can be pushed down with one hand and the knife carriage displaced with the other hand; this is much simpler in terms of handling than with known rotary cutting devices, in which the knife carriage must be pushed down and simultaneously displaced.

Provision is further made according to the invention for the guide bar to be retainable in the cutting position at its vertically movable end(s) with an immobilization device or devices. The guide bar is thereby immobilized for the cutting operation and cannot move by itself, and need not be pushed down during the cutting operation if a spring is working against it. This simplifies operation of the cutting unit.

The or each immobilization device is preferably embodied as a snap device into which the guide bar automatically and disengageably snaps upon movement into the cutting position, so that immobilization of the guide bar in the cutting position is not associated with additional actions. All that is necessary for the disengagement operation after the cutting operation is an actuation of the snap device in order to disengage it. The snap device can have for that purpose an actuation slider that is mounted at an appropriate location.

### DESCRIPTION OF THE FIGURES

The invention is illustrated in more detail, with reference to exemplary embodiments, in the drawings, in which:

FIG. 1 is an oblique view of the cutting unit according to the present invention, before the cutting operation;

FIG. 2 is the oblique view according to FIG. 1, after the cutting operation; and

FIG. 3 is an oblique view of a second embodiment of a cutting unit, restricted to the corner region having the free end of the guide bar.

### DETAILED DESCRIPTION OF THE PREFERRED EMBODIMENT(S)

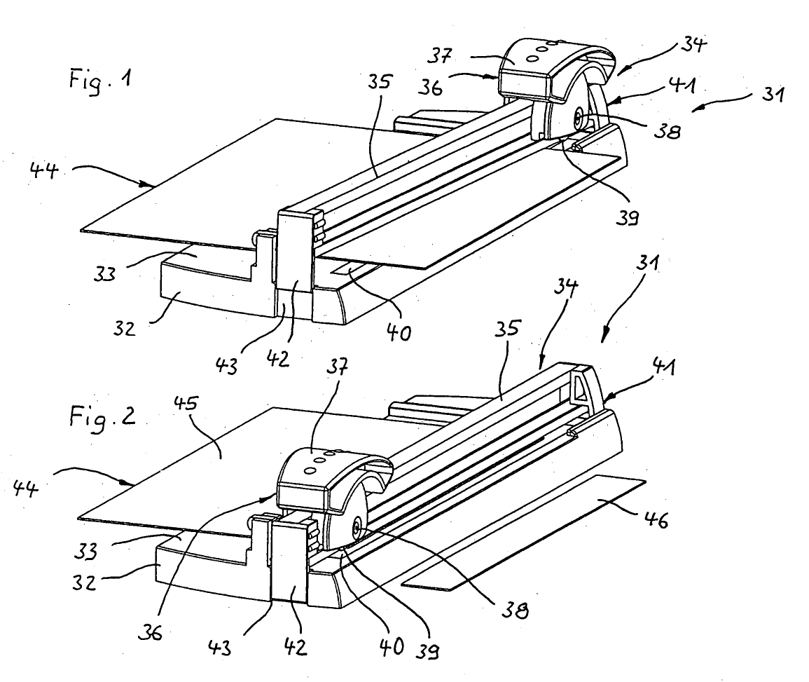

Cutting unit 31 depicted in FIGS. 1 and 2 comprises a frame plate 32, substantially rectangular in plan, whose horizontal upper side forms a bed 33 for sheet material to be trimmed. A rotary cutting device 34 is located on the front (in this view) longitudinal side of frame plate 32.

Rotary cutting device 34 comprises a guide bar 35 that extends, at a distance from bed 33, parallel to the longitudinal side of frame plate 32. A knife carriage 36 is guided, displaceably in the direction of the longitudinal axis of guide bar 35, on guide bar 35. It surrounds guide bar 35 in U-shaped fashion and has on the upper side an attachment 37 with which knife carriage 36 can be slid manually back and forth. Knife carriage 36 has, on the front (in this view) side, a bearing shaft 38 which extends horizontally and transversely with respect to the longitudinal axis of guide bar 35, and on which a circular knife 39 is mounted in freely rotatable fashion. Attached on bed 33 below circular knife 39 is a support surface 40 that is made of an elastomeric material. It extends over the entire movement range of circular knife 39.

Guide bar 35 is joined pivotably, at the end located remotely in the views, to frame plate 32 via a pivot bearing 41. The pivot axis extends horizontally and transversely to the longitudinal axis of guide bar 35. Access to the gap between guide bar 35 and bed 33 is blocked by pivot bearing 41 in the region of this end of guide bar 35. At the other end, guide bar 35 comprises a downwardly directed protective tab 42. The latter fits into a guide groove 43 that is shaped into the short longitudinal side of frame plate 32 in such a way that protective tab 42 is enclosed on both sides and laterally guided.

In FIG. 1, guide bar 35 is located in an upwardly pivoted initial position, so that circular knife 39 is raised away from support surface 40 and a sheet material 44 to be trimmed can be slid without impediment through the gap between guide bar 35 and bed 33. In this position, guide bar 35 is held by a spring arranged close to pivot bearing 41, knife carriage 36 being located adjacent to pivot bearing 41. In this position, the lower end of protective tab 42 still projects into guide groove 43 so that the gap between guide bar 35 and bed 33 is inaccessible from this end as well.

For the cutting operation, guide bar 35 is pivoted downward against the spring and then assumes the position depicted in FIG. 2, in which it extends substantially parallel to bed 33. In that context, circular knife 39 comes into contact against support surface 40. Knife carriage 36 is then displaced out of the position shown in FIG. 1 in the direction of the free end of guide bar 35 with slight pressure on support surface 40, in which context circular knife 39 performs a rotary movement and simultaneously cuts sheet material 44. Trimmed sheet material portion 45 resting on bed 33, and cut-off sheet material portion 46, remain behind.

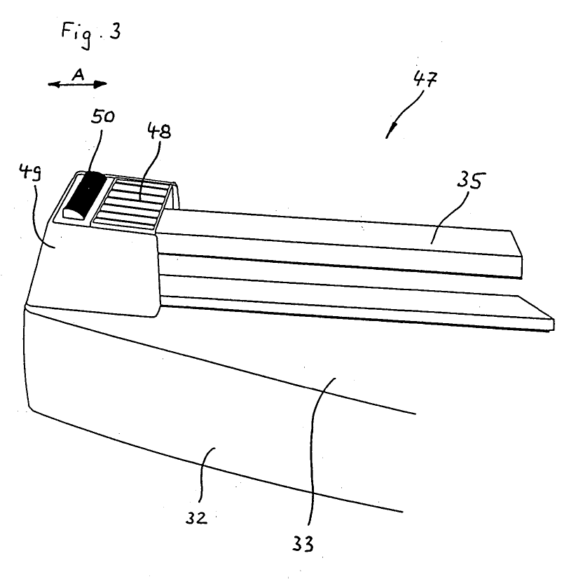

Cutting unit 47 depicted in FIG. 3 differs from cutting unit 31 only in the configuration of the region at the free end of guide bar 35; for identical or functionally identical parts, therefore, the reference numbers already used for FIGS. 1 and 2 are adopted for the description of this embodiment of cutting unit 47, and reference is made to the previous description. Only the differences will be presented below.

Instead of protective tab 42, guide bar 35 has at its free end a superimposed terminating block 48 that is enclosed on both sides by a guide block 49 embodied as a horizontal U and is thereby guided transversely to its longitudinal axis. Shaped into the end surface of terminating block 48 is a recess (not depicted in detail here) into which fits a catch guided in guide block 49. The catch is joined rigidly to an actuation slider 50 that is guided displaceably in the directions of double arrow A, actuation slider 50 being tensioned by a spring in the direction toward terminating block 48.

In the depiction shown, guide bar 35 is located in the (lower) cutting position and is held in that position by the catch, so that the cutting operation can be performed with no need to push guide bar 35 down. After the cutting operation, actuation slider 50 is displaced to the left, i.e. away from terminating block 48, so that the catch moves out of the recess in the end surface of terminating block 48 and guide bar 35 is released. The latter then pivots automatically, because of the action of the spring, into the upper initial position. For another cutting operation, guide bar 35 is once again pivoted toward bed 33. When the cutting position is reached, the catch snaps into the recess in terminating block 48 and thus once again retains guide bar 35.

1. A cutting unit (1) for trimming sheet material (44) such as paper, films, or the like, comprising a planar bed (33) for supporting the sheet material (44) and a rotary cutting device (34) that has a knife carriage (36) displaceable on a guide bar (35) and a circular knife (39) rotatably mounted thereon,
wherein the guide bar (35) is raisable from a lower cutting position into an upper initial position, and lowerable from the latter back into the cutting position; and the gap between bed (33) and guide bar (35) is inaccessible from the ends of the guide bar (35).

2. The cutting unit as defined in claim 1, wherein the guide bar (35) is guided in vertically displaceable fashion in the region of its ends.

3. The cutting unit as defined in claim 2, wherein the guide bar is raisable by 5 to 20 mm.

4. The cutting unit as defined in claim 1, wherein the guide bar (35) is mounted pivotably about a horizontal axis in the region of one end.

5. The cutting unit as defined in claim 4, wherein the guide bar (35) is pivotable through an angle of at most 10°.

6. The cutting unit as defined in claim 1, wherein the end(s) of the guide bar (35) overlap(s) the bed (33).

7. The cutting unit as defined in claim 6, wherein each overlapping end of the guide bar (35) has a downwardly projecting protective tab (42) overlapping the bed (33).

8. The cutting unit as defined in claim 7, wherein the protective tab (42) is laterally guided in a slot (43) in the bed (33).

9. The cutting unit as defined in claim 1, wherein without actuation, the guide bar (35) assumes the cutting position.

10. The cutting unit as defined in Clam 1, wherein without actuation, the guide bar (35) is held in the upper position by means of a spring.

11. The cutting unit as defined in claim 1, wherein the guide bar (35) is retainable in the cutting position at its vertically movable end(s) by means of an immobilization device (48) or devices.

12. The cutting unit as defined in claim 11, wherein the or each immobilization device (48) is embodied as a snap device into which the guide bar (35) automatically and disengageably snaps upon movement into the cutting position.

13. The cutting unit as defined in claim 12, wherein the snap device has an actuation slider (50) with which the snap device is disengageable.
